(19) United States
(12) Patent Application Publication
(10) Pub. No.: US 2020/0323031 A1
(43) Pub. Date: Oct. 8, 2020

(54) BASE STATION APPARATUS, TERMINAL APPARATUS, AND COMMUNICATION METHOD FOR THESE APPARATUSES

(71) Applicants: SHARP KABUSHIKI KAISHA, Sakai City, Osaka (JP); FG Innovation Company Limited, Tuen Mun, New Territories (HK)

(72) Inventors: OSAMU NAKAMURA, Sakai City, Osaka (JP); JUNGO GOTO, Sakai City, Osaka (JP); YASUHIRO HAMAGUCHI, Sakai City, Osaka (JP)

(21) Appl. No.: 16/956,853

(22) PCT Filed: Dec. 5, 2018
(86) PCT No.: PCT/JP2018/044713

§ 371 Date: Jun. 22, 2020

(30) Foreign Application Priority Data
Dec. 27, 2017 (JP) 2017-251432

(51) Int. Cl. H04W 88/02; H04W 88/08; H04B 7/06; H04L 5/00; H04W 76/27; H04W 80/08; H04W 72/04; H04L 1/00

(52) U.S. Cl. CPC H04W 88/02; H04W 88/08; H04B 7/0626; H04L 1/0061; H04W 76/27; H04W 80/08; H04W 72/042; H04L 5/0051

(57) ABSTRACT

A terminal apparatus for communicating with a base station apparatus, the terminal apparatus including: a radio receiving unit configured to receive a CSI reference signal; a controller configured to calculate channel state information (CSI); and a transmitter configured to transmit the CSI, wherein the controller calculates the CSI, based on an RRC parameter related to the number of repetitions in a case that a transport block error rate to be used in calculating the CSI is configured by a higher layer processing unit, and calculates the CSI that is not dependent on the RRC parameter related to the number of repetitions in a case that the transport block error rate to be used in calculating the CSI is not configured by the higher layer processing unit.

### TECHNICAL FIELD

The present invention relates to a base station apparatus, a terminal apparatus, and a communication method for these apparatuses.

This application claims priority to JP 2017-251432 filed on Dec. 27, 2017, the contents of which are incorporated herein by reference.

### BACKGROUND ART

In the Long Term Evolution (LTE) communication system standardized by Third Generation Partnership Project (3GPP), in downlink, an adaptation modulation (Link adaptation, Rank adaptation) is applied that adaptively controls a coding rate, a modulation scheme, and a rank (the number of streams, the number of layers) according to a channel state. Adaptive modulation allows transmission at an appropriate transmission rate depending on channel quality.

In order to perform adaptive modulation in the downlink, a base station apparatus needs to know a channel quality of a terminal apparatus, and determine a coding rate, a modulation scheme, or a rank in accordance with the channel quality. In a case of an FDD system, a base station apparatus transmits a reference signal, the terminal apparatus calculates the channel quality by using the received reference signal, and the terminal apparatus transmits the calculated channel quality to the base station apparatus. Transmitting the calculated channel quality to the base station apparatus by the terminal apparatus is referred to as Channel State Information (CSI) reporting in LTE. In LTE, CSI reporting is broadly classified into periodic CSI reporting and aperiodic CSI reporting. In periodic CSI reporting, the terminal apparatus basically periodically (regularly) transmits by using the Physical Uplink Control CHannel (PUCCH), which is a channel for transmitting control signals. On the other hand, in aperiodic CSI reporting, in a case that the base station apparatus needs CSI of a certain terminal apparatus, the base station apparatus transmits a signal of the Physical Downlink Control CHannel (PDCCH) to the terminal apparatus, and the terminal apparatus receiving the PDCCH transmits CSI by using the Physical Uplink Shared CHannel (PUSCH), which is a channel for transmitting information. The base station apparatus knows the CSI of the terminal apparatus by the two CSI reporting described above, and uses the CSI for the adaptive modulation.

In 3GPP, with enhanced Mobile Broad Band (eMBB) for the purpose of ultra high speed transmission, Ultra-Reliable and Low Latency Communications (URLLC) for the purpose of high reliability and low latency, and massive Machine-Type Communications (mMTC) for the purpose of accommodating a number of terminals as use cases, the fifth generation mobile communication (New Radio (NR)) is being standardized mainly for eMBB. In standardization, it is determined to employ semi-persistent CSI reporting in addition to periodic CSI reporting and aperiodic CSI reporting employed in LTE. In semi-persistent CSI reporting, a method using the PUCCH and a method using the PUSCH have been proposed. The method using the PUCCH is agreed to perform activation and deactivation of the SP-CSI reporting by using the MAC CE. On the other hand, in SP-CSI reporting using the PUSCH, the CSI reporting is performed by using radio resources ensured in the SPS scheme by using a method for ensuring radio resources introduced in LTE as semi-persistent scheduling (SPS). (NPL 1, and NPL 2)

### CITATION LIST

### Non Patent Literature

NPL 1: Ericsson, “On UL Data Transmission Procedures”, R1-1721015.

NPL 2: NTT DOCOMO, “UL data transmission procedure”, R1-1720824.

### SUMMARY OF INVENTION

### Technical Problem

In the eMBB, CSI for which the Block Error Rate (BLER) is less than or equal to 10% is calculated, but the request BLER of the URLLC is 0.001%, and therefore, the request BLER is not satisfied in a case that the CSI is calculated in the same manner as for the eMBB. Therefore, it has been proposed that CSI can be calculated for which the BLER is X % or less during the CSI calculation. Here, the value of X can be configured by a higher layer parameter, and values such as 1% and 0.001% can be configured.

In LTE and NR, conditions for calculating CSI in the terminal are defined in addition to the BLER. However, this is for optimizing NR assuming LTE or eMBB, and the CSI needs to be calculated and reported to the base station apparatus under conditions different from LTE or eMBB in a case that URLLC is applied.

Furthermore, even in a case that an appropriate MCS is selected by the CSI reporting and the BLER in the downlink data transmission is less than 0.001%, in a case that the transport block error rate (BLER) of the uplink control information (ACK or NACK) transmitted by the terminal apparatus exceeds 0.001%, an error rate of 0.001% or less cannot be realized as a system.

An aspect of the present invention has been made in view of such circumstances, and an object of the present invention is to provide a method for generating and a method for transmitting control information for realizing URLLC.

### Solution to Problem

To address the above-mentioned drawbacks, a base station apparatus, a terminal apparatus, and a communication method according to an aspect of the present invention are configured as follows.

(1) An aspect of the present invention is a terminal apparatus for communicating with a base station apparatus, the terminal apparatus including: a radio receiving unit configured to receive a CSI reference signal; a controller configured to calculate channel state information (CSI); and a transmitter configured to transmit the CSI, wherein the controller calculates the CSI, based on an RRC parameter related to the number of repetitions in a case that a transport block error rate to be used in calculating the CSI is configured by a higher layer processing unit, and calculates the CSI that is not dependent on the RRC parameter related to the number of repetitions in a case that the transport block error rate to be used in calculating the CSI is not configured by the higher layer processing unit.

(2) In an aspect of the present invention, the controller further calculates the CSI, based on an RRC parameter related to redundancy version for repetition, in a case that the transport block error rate is configured by the higher layer processing unit.

(3) In an aspect of the present invention, the controller calculates the CSI by a different CSI process depending on the transport block error rate.

(4) An aspect of the present invention is a base station apparatus for communicating with a terminal apparatus, the base station apparatus including: a radio receiving unit configured to receive channel state information (CSI) transmitted by the terminal apparatus; a higher layer processing unit configured to configure a transport block error rate; a downlink control signal generation unit configured to generate a downlink control signal including a parameter of PDSCH; and a radio transmitting unit configured to transmit the transport block error rate and the downlink control signal to the terminal apparatus, wherein the downlink control signal generation unit generates downlink control information, based on a higher layer parameter related to the number of repetitions by the terminal apparatus, in a case that the transport block error rate is configured in the higher layer processing unit.

### Advantageous Effects of Invention

According to one or more aspects of the present invention, the base station apparatus and the terminal apparatus can calculate and utilize appropriate control information for URLLC, or the like.

### BRIEF DESCRIPTION OF DRAWINGS

FIG. 1 is a diagram illustrating an example of a configuration of a communication system 1 according to the first embodiment.

FIG. 2 is a diagram illustrating an example of a configuration of a base station apparatus according to the first embodiment.

FIG. 3 is a diagram illustrating an example of a configuration of a terminal apparatus according to the first embodiment.

### DESCRIPTION OF EMBODIMENTS

A communication system according to the present embodiments includes a base station apparatus (a cell, a small cell, a serving cell, a component carrier, an eNodeB, a Home eNodeB, and a gNodeB) and a terminal apparatus (a terminal, a mobile terminal, and User Equipment (UE)). In the communication system, in a case of a downlink, the base station apparatus serves as a transmitting apparatus (a transmission point, a transmit antenna group, a transmit antenna port group, or a Tx/Rx Point (TRP)), and the terminal apparatus serves as a receiving apparatus (a reception point, a reception terminal, a receive antenna group, or a receive antenna port group). In a case of an uplink, the base station apparatus serves as a receiving apparatus, and the terminal apparatus serves as a transmitting apparatus. The communication system is also applicable to Device-to-Device (D2D) communication. In this case, the terminal apparatus serves both as a transmitting apparatus and as a receiving apparatus.

The communication system is not limited to data communication between the terminal apparatus and the base station apparatus, the communication involving human beings, but is also applicable to a form of data communication requiring no human intervention, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multi-carrier transmission scheme, such as a Cyclic Prefix-Orthogonal Frequency Division Multiplexing (CP-OFDM). The communication system may use, in the uplink, a transmission scheme, such as a Discrete Fourier Transform Spread-Orthogonal Frequency Division Multiplexing (DFTS-OFDM, also referred to as an SC-FDMA). Although the following describes a case of using an OFDM transmission scheme in the uplink and the downlink, the transmission scheme is not limited to this and another transmission scheme is applicable.

The base station apparatus and the terminal apparatus according to the present embodiments can communicate in a frequency band for which an approval of use (license) has been obtained from the government of a country or region where a radio operator provides services, that is, a so-called licensed band, and/or in a frequency band for which no approval (license) from the government of the country or region is required, that is, a so-called unlicensed band.

According to the present embodiments, “X/Y” includes the meaning of “X or Y”. According to the present embodiments, “X/Y” includes the meaning of “X and Y”. According to the present embodiments, “X/Y” includes the meaning of “X and/or Y”.

### First Embodiment

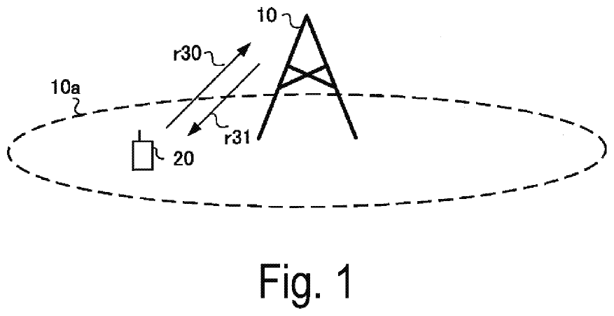

FIG. 1 is a diagram illustrating a configuration example of a communication system 1 according to the present embodiment. The communication system 1 according to the present embodiment includes a base station apparatus 10 and a terminal apparatus 20. Coverage 10a is a range (a communication area) in which the base station apparatus 10 can connect to the terminal apparatus 20 (coverage 10a is also referred to as a cell). Note that the base station apparatus 10 can accommodate multiple terminal apparatuses 20 in the coverage 10a.

In FIG. 1, an uplink radio communication r30 at least includes the following uplink physical channels. The uplink physical channels are used for transmitting information output from a higher layer.
Physical Uplink Control Channel (PUCCH)
Physical Uplink Shared Channel (PUSCH)
Physical Random Access Channel (PRACH)

The PUCCH is a physical channel that is used to transmit Uplink Control Information (UCI). The uplink control information includes a positive acknowledgement (ACK)/Negative acknowledgement (NACK) in response to downlink data (a Downlink transport block, a Medium Access Control Protocol Data Unit (MAC PDU), a Downlink-Shared Channel (DL-SCH), and a Physical Downlink Shared Channel (PDSCH). The ACK/NACK is also referred to as a Hybrid Automatic Repeat request ACKnowledgement (HARQ-ACK), a HARQ feedback, a HARQ response, or a signal indicating HARQ control information or a delivery confirmation.

NR supports at least five formats including PUCCH format 0, PUCCH format 1, PUCCH format 2, PUCCH format 3, and PUCCH format 4. PUCCH format 0 and PUCCH format 2 include one or two OFDM symbols, and the other PUCCHs include 4 to 14 OFDM symbols. The bandwidths of PUCCH format 0 and PUCCH format 1 include 12 subcarriers. In PUCCH format 0, one bit (or two bits) of ACK/NACK is transmitted on resource elements of 12 subcarriers and one OFDM symbol (or two OFDM symbols).

One bit (or two bits) of ACK/NACK information is spread and transmitted in 12 (or 24) resource elements, but it is considered that resource elements are not sufficient for the error rate of the PUCCH to be less than 0.001%. In order to increase the number of resource elements, PUCCH format 1 may be used, but because the PUCCH equal to or greater than four OFDM symbols is used, there is a problem in that delay time until the base station apparatus receives the ACK/NACK is increased.

Thus, it is considered to increase the number of subcarriers used. By increasing the number of subcarriers used to 24, 36, 48, and so forth, by the higher layer signaling, a number of subcarriers can be used, so the error rate of the PUCCH can be reduced. In a case that the higher layer signaling is not configured, the number of subcarriers in PUCCH format 0 (and PUCCH format 1) is 12, and only in a case that a higher layer parameter is configured, the number of subcarriers is increased by two times, three times, four times, and so forth. Here, in a radio resource control (RRC) parameter, any one of the values of two times, three times, four times, and so forth is configured. Note that candidates of the parameter may include [24, 36, 48, 60], or may include [* 2, * 3, * 4, * 5]. The number of candidate parameters may be four, may be eight, or may be any value. The spacing between candidate parameters is not limited to 12 subcarriers, but may be any value. Furthermore, spare (reserve) may be included.

Next, a description will be given of a method for allocating resources. In a case that the number of resource blocks (subcarriers) used increases by the RRC signaling as described above, the resource block indicated in a case of no RRC parameter represents the start and is used continuously until the number of subcarriers configured by an RRC parameter. Note that the PUCCH may be discretely allocated by another RRC signaling.

Note that, for the sequences used in PUCCH format 0, PUCCH format 1, and the like, a sequence corresponding to the number of subcarriers used is used rather than repeatedly using a sequence of length 12 in the frequency domain. As a result, the PAPR/CM of the transmission signal can be suppressed compared to a case that a sequence of length 12 is repeatedly used.

A method of using multi-antenna is used as a method for reducing the error rate of the PUCCH. In PUCCH format 0 and PUCCH format 1, different information is transmitted to the base station apparatus by providing different cyclic shifts with respect to the QPSK sequence including 12 symbols. For example, in NR, the cyclic shift is specified to indicate “0” in a case that the value of the parameter m is 0, and “1” in a case that the value of the parameter m is 6. In a case that two transmit antennas (antenna ports) are employed, the same information (“0” or “1”) can be transmitted from each transmit antenna at a different cyclic shift by setting “0” in a case that the value of m is 3 and “1” in a case that the value of m is 9. However, in the timing at which an SR is transmitted (OFDM symbol, slot, mini-slot), m=3 and 9 indicate positive SR, so a value other than 3 and 9 is allocated. For example, “0” in a case that the value of m is 1, “1” in a case that the value of m is 7, or the like, is set. This value may be applied only to the timing at which an SR is transmitted, or may be applied in a case that multi-antenna is applied other than the timing at which an SR is transmitted. In other words, in a case of transmitting the same information on multiple antenna ports, a favorable transmission quality can be obtained in the base station apparatus, which is a receiver, by providing different cyclic shifts for each transmit antenna port.

Methods for reducing the error rate of the PUCCH include a method of performing transmission by using the PUSCH rather than the PUCCH, in other words, a method of applying a piggyback. Thus, in a case that a BLER lower than 0.1 is configured for the RRC parameter (or in a case that a CQI table different from a CQI table used in a case that the BLER is 0.1 is configured by RRC signaling), the error rate can be reduced by performing piggyback by using the PUSCH rather than transmitting ACK/NACK by using the PUCCH. In a case of performing piggyback, configuration by RRC signaling is required, but in a case that a BLER lower than 0.1 is configured (or in a case that a CQI table different from the CQI table used in a case that the BLER is 0.1 is configured by RRC signaling), ACK/NACK is transmitted by piggyback even in a case that RRC signaling related to piggyback is not configured. Here, the control information is not limited to ACK/NACK, but may include uplink control information (UCI) such as SR, CSI (CQI, RI, PMI), or the like. Here, piggyback refers to transmission of UCI on the PUSCH. Therefore, it is not necessary to include information data other than the UCI, and the PUSCH may be configured only by the UCI.

The uplink control information includes a Scheduling Request (SR) used to request a PUSCH (Uplink-Shared Channel (UL-SCH)) resource for initial transmission. The scheduling request indicates that the UL-SCH resource for initial transmission is requested.

The uplink control information includes downlink Channel State Information (CSI). The downlink channel state information includes a Rank Indicator (RI) indicating a preferable spatial multiplexing order (the number of layers), a Precoding Matrix Indicator (PMI) indicating a preferable precoder, a Channel Quality Indicator (CQI) designating a preferable transmission rate, and the like. The PMI indicates a codebook determined by the terminal apparatus. The codebook is related to precoding of the physical downlink shared channel. The CQI can use an index (CQI index) indicative of a preferable modulation scheme (for example, QPSK, 16QAM, 64QAM, 256QAMAM, or the like), a preferable coding rate, and a preferable frequency utilization efficiency in a prescribed band. The terminal apparatus selects, from the CQI table, a CQI index considered to allow a transport block on the PDSCH to be received but exceeding a prescribed block error probability (BLER, for example, an error rate of 0.1). However, the BLER can be configured with higher layer parameters, and values such as 0.000001, 0.00001, 0.0001, 0.001 and 0.01 can be configured. The value of BLER is not limited to the above, and may be any value.

In NR for eMBB, in a CSI reference signal, the terminal apparatus assumes the following for the purpose of deriving a CQI index. In a case of being configured, the same assumptions are given for PMI and RI.
First 2 OFDM symbols are filled by a control signal
The number of PDSCH symbols is 12
Subcarrier spacing of Bandwidth Part configured for PDSCH reception or bandwidth configured for PDSCH reception
Reference signal uses CP length and subcarrier spacing configured for PDSCH reception
No resource element is used by primary and secondary synchronization signals, or PBCH
Redundancy version 0
The ratio of EPRE of PDSCH to EPRE of CSI-RS is given from a higher layer
No resource element is allocated to CSI-RS and zero power CSI-RS
Assume the number of front-loaded DMRSs having the same number as the maximum number of front-loaded DMRSs configured by a higher layer parameter
Assume the number of DMRSs having the same number as additional DMRSs configured by a higher layer parameter
Assume that PDSCH does not include a DMRS
Transmission of the base station apparatus is the transmission scheme of PDSCH in a case that the terminal apparatus assumes that up to eight transmission layers are performed at the antenna ports (1000 to 1011)

In the URLLC, since transmission of a mini-slot (2/4/7 OFDM symbol unit) is primarily performed rather than a slot (14 OFDM symbol unit) based transmission, it is necessary to assume the number of symbols in which the number of PDSCH (OFDM) symbols assumed above is less than 12. Therefore, in the present embodiment, the number of PDSCH (OFDM) symbols to be assumed is configured by a higher layer parameter. In this way, the CQI index is calculated with the number of PDSCH symbols fixed as 12, while a phenomenon in which a prescribed BLER is not satisfied can be avoided in a case that the PDSCH is transmitted from the base station apparatus in a mini-slot having a small number of PDSCH symbols. In a case of not being configured by RRC signaling, the value may be set to 12, and the value may be updated by RRC signaling. The value that can be configured by RRC signaling may be any value as long as it is an integer of 1 or greater. Note that the number of PDSCH (OFDM) symbols assumed may not be notified by higher layer signaling, but may be notified by a field for specifying the number of PDSCH (OFDM) symbols in the most recent DCI (downlink control information) format or the DCI format for the SP-CSI reporting, from the base station apparatus to the terminal apparatus. Different CSI processes may be configured to distinguish CSI reporting for eMBB and for URLLC. A prescribed BLER or the number of PDSCH (OFDM) symbols described above may be configured for each process.

In a case that mini-slot based transmission is performed in the URLLC, control information may not be included in the mini-slot. Thus, in the CSI reporting for the URLLC, one of the conditions described above “initial two OFDM symbols are filled by a control signal” is disabled (ignored) or is considered as “initial 0 OFDM symbol is filled by a control signal”. Whether or not it is “CSI reporting for the URLLC” described above may be determined based on whether or not the configuration related to the number of PDSCH (OFDM) symbols described above is configured by RRC signaling (or MAC CE or DCI format).

Next, CQI tables to be referenced will be described. There are two types of CQI tables used in a case that the BLER is configured to 0.1, in other words, for eMBB transmissions. One is a CQI table (first CQI table) including QPSK, 16QAM, 64QAM, and the other is a CQI table (second CQI table) including QPSK, 16QAM, 64QAM, and 256QAM. There may be further a CQI table including 1024QAM, but a case that two tables are present will be described below. Which of the two tables is used in NR is selected by RRC signaling. On the other hand, for the URLLC transmission, in other words, in a case that a value smaller than 0.1 is configured as the BLER, the first CQI table is used regardless of the configuration of the RRC parameter related to CQI table. Thus, also for the MCS table used in the PDSCH, the MCS is selected based on the first MCS table among the first MCS table (MCS table including QPSK, 16QAM, and 64QAM) and the second CQI table (CQI table including QPSK, 16QAM, 64QAM, and 256QAM). Here, in a case that an RRC parameter related to MCS table in the PDSCH is present, the MCS table may be selected based on the information. Note that in a case of Semi-Persistent Scheduling (SPS) (Grant-Free (GF), Configured (grant) Scheduling) based on SPS C-RNTI (or CS RNTI), the PDCCH may be enabled and the SPS may be activated only in a case that the most significant bit (MSB) is configured to 0. Here, in a case that other than SPS, in other words, for example, dynamic scheduling by C-RNTI is applied, all elements of the MCS table may be enabled, in other words, the most significant bit may be used to determine the MCS, or the MCS table may be selected based on the RRC signaling. Whether or not it is CSI reporting for the URLLC may be a case that the RRC parameter related to the CQI table indicates a CQI table different than the CQI table used (configured) in a case that the BLER is 0.1, or may be a case that the BLER is configured by RRC signaling.

Next, a case is considered that repetitive transmissions are prescribed in the transmission for the URLLC. The number of repetitions is configured by an RRC parameter. Note that the number of repetitions may be configured by DCI. In a case that the number of repetitions is not configured, the number of repetitions is 1. The terminal apparatus calculates the CQI index, assuming the number of repetitions configured. Here, in a case that two codewords are present, the number of repetitions is configured to the same number of repetitions for both. Note that, even in a case that the number of repetitions is configured as an RRC parameter, the number of repetitions may be configured to not be considered during the CSI calculation in order to secure BLER in the first time of the repetitions. Alternatively, the higher layer processing unit may configure whether or not to calculate CSI in consideration of the number of repetitions. Furthermore, in a case of configuring the signaling, based on the RRC parameter related to the number of repetitions, the CSI may be calculated in accordance with the RRC parameter related to the redundancy version in the repetition. The RRC parameter related to the redundancy version is a parameter of how to use four redundancy versions {0,1,2,3}, and in a case that the number of repetitions is four, there are {0,0,0,0}, {0,2,3,1}, {0,3,0,3}, and the like. In a case that the number of repetitions exceeds four times, the configuration is repeated.

Next, the base station apparatus will be described. In a case that the transport block error rate is configured by the higher layer processing unit, the downlink control signal generation unit configures the MCS in consideration of the conditions assumed in the CSI calculation by the terminal apparatus, and notifies (transmits) the configured MCS to the terminal apparatus as DCI. The conditions are those described above, including the number of repetitions configured by RRC signaling, the pattern of the redundancy version at the time of repetition, the MCS table used, the restrictions on the MCS, the number of OFDM symbols in the control signal, the number of PDSCHs, the CSI process number, the scheduling type (dynamic scheduling, SPS, GF type 1, GF type 2, Configured (grant) Scheduling), and the like.

The PUSCH is a physical channel used to transmit uplink data (an Uplink Transport Block, an Uplink-Shared Channel (UL-SCH)), and CP-OFDM or DFT-S-OFDM is applied as a transmission scheme. The PUSCH may be used to transmit the HARQ-ACK in response to the downlink data and/or the channel state information along with the uplink data. The PUSCH may be used to transmit only the channel state information. The PUSCH may be used to transmit only the HARQ-ACK and the channel state information.

The PUSCH is used to transmit radio resource control (Radio Resource Control (RRC)) signaling. The RRC signaling is also referred to as an RRC message/RRC layer information/an RRC layer signal/an RRC layer parameter/an RRC information element. The RRC signaling is information/signal processed in a radio resource control layer. The RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, user equipment-specific (user equipment-unique) information is transmitted using the signaling dedicated to the certain terminal apparatus. The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a power headroom may be included in the MAC CE and may be reported via the physical uplink shared channel. In other words, a MAC CE field is used to indicate a level of the power headroom. The uplink data can include the RRC message and the MAC CE. The RRC signaling and/or the MAC CE is also referred to as a higher layer signal (higher layer signaling). The RRC signaling and/or the MAC CE are included in a transport block.

The PRACH is used to transmit a preamble used for random access. The PRACH is used to transmit a random access preamble. The PRACH is used for indicating the initial connection establishment procedure, the handover procedure, the connection re-establishment procedure, synchronization (timing adjustment) for uplink transmission, and the request for the PUSCH (UL-SCH) resource.

In the uplink radio communication, an Uplink Reference Signal (UL RS) is used as an uplink physical signal. The uplink physical signal is not used for transmission of information output from higher layers, but is used by the physical layer. The uplink reference signal includes a Demodulation Reference Signal (DMRS) and a Sounding Reference Signal (SRS). The DMRS is associated with transmission of the physical uplink-shared channel/physical uplink control channel. For example, the base station apparatus 10 uses the demodulation reference signal to perform channel estimation/channel compensation in a case of demodulating the physical uplink-shared channel/the physical uplink control channel.

The SRS is not associated with the transmission of the physical uplink shared channel/the physical uplink control channel. The base station apparatus 10 uses the SRS to measure an uplink channel state (CSI Measurement).

In FIG. 1, at least the following downlink physical channels are used in radio communication of the downlink r31. The downlink physical channels are used for transmitting information output from the higher layer.
Physical Broadcast Channel (PBCH)
Physical Downlink Control Channel (PDCCH)
Physical Downlink Shared Channel (PDSCH)

The PBCH is used for broadcasting a Master Information Block (MIB, a Broadcast Channel (BCH)) that is used commonly by the terminal apparatuses. The MIB is one of pieces of system information. For example, the MIB includes a downlink transmission bandwidth configuration and a System Frame number (SFN). The MIB may include information for indicating at least some of the number of the slot in which PBCH is transmitted, the number of the subframe in which PBCH is transmitted, and the number of the radio frame in which PBCH is transmitted.

The PDCCH is used to transmit Downlink Control Information (DCI). For the downlink control information, multiple formats based on applications (also referred to as DCI formats) are defined. The DCI format may be defined based on the type and the number of bits of the DCI constituting a single DCI format. Each format is used depending on the application. The downlink control information includes control information for downlink data transmission and control information for uplink data transmission. The DCI format for the downlink data transmission is also referred to as a downlink assignment (or downlink grant). The DCI format for the uplink data transmission is also referred to as an uplink grant (or uplink assignment).

A single downlink assignment is used for scheduling a single PDSCH in a single serving cell. The downlink grant may be used for at least scheduling of the PDSCH within the same slot as the slot in which the downlink grant has been transmitted. The downlink assignment includes downlink control information, such as a resource block allocation for the PDSCH, a Modulation and Coding Scheme (MCS) for the PDSCH, a NEW Data Indicator (NDI) for indicating initial transmission or retransmission, information for indicating the HARQ process number in the downlink, and a Redundancy version for indicating an amount of redundancy added to the codeword during error correction coding. The codeword is data after the error correcting coding. The downlink assignment may include a Transmission Power Control (TPC) command for the PUCCH and a TPC command for the PUSCH. The uplink grant may include a Repetition number for indicating the number of repetitions for transmission of the PUSCH. Note that the DCI format for each downlink data transmission includes information (fields) required for the application among the above-described information.

A single uplink grant is used for notifying the terminal apparatus of scheduling of a single PUSCH in a single serving cell. The uplink grant includes uplink control information, such as information on the resource block allocation for transmission of the PUSCH (resource block allocation and hopping resource allocation), information on the MCS for the PUSCH (MCS/Redundancy version), the number of cyclic shifts performed on the DMRS, information on retransmission of the PUSCH, a TPC command for the PUSCH, and a request for downlink Channel State Information (CSI)(CSI request). The uplink grant may include information for indicating the HARQ process number in the uplink, a Transmission Power Control (TPC) command for the PUCCH, and a TPC command for the PUSCH. Note that the DCI format for each uplink data transmission includes information (fields) required for the application among the above-described information.

The PDCCH is generated by adding a Cyclic Redundancy Check (CRC) to the downlink control information. In the PDCCH, CRC parity bits are scrambled with a prescribed identifier (also referred to as an exclusive OR operation, mask). The parity bits are scrambled with a Cell-Radio Network Temporary Identifier (C-RNTI), a Semi Persistent Scheduling (SPS)C-RNTI, a Temporary C-RNTI, a Paging (P)-RNTI, a System Information (SI)-RNTI, or a Random Access (RA)-RNTI. The C-RNTI and the SPS C-RNTI are identifiers for identifying a terminal apparatus within a cell. The Temporary C-RNTI is an identifier for identifying the terminal apparatus that has transmitted a random access preamble in a contention based random access procedure. The C-RNTI and the Temporary C-RNTI are used to control PDSCH transmission or PUSCH transmission in a single subframe. The SPS C-RNTI (CS-RNTI) is used to periodically allocate a resource for the PDSCH or the PUSCH. The P-RNTI is used to transmit a paging message (Paging Channel (PCH)). The SI-RNTI is used to transmit the SIB, and the RA-RNTI is used to transmit a random access response (a message 2 in a random access procedure).

The PDSCH is used to transmit the downlink data (the downlink transport block, DL-SCH). The PDSCH is used to transmit a system information message (also referred to as a System Information Block (SIB)). Some or all of the SIBs can be included in the RRC message.

The PDSCH is used to transmit the RRC signaling. The RRC signaling transmitted from the base station apparatus may be common to the multiple terminal apparatuses in the cell (unique to the cell). That is, the information common to the user equipments in the cell is transmitted using the RRC signaling unique to the cell. The RRC signaling transmitted from the base station apparatus may be a message dedicated to a certain terminal apparatus (also referred to as dedicated signaling). In other words, user equipment-specific (user equipment-unique) information is transmitted by using the message dedicated to the certain terminal apparatus.

There are various RRC signaling transmitted by the PDSCH, for example, there is information related to SP-CSI reporting. The information related to SP-CSI reporting includes information for indicating which information to notify and which information to not notify, among a cycle for transmitting the SP-CSI, a time domain offset value in a symbol unit or a slot unit, information related to a rank (Rank Indicator (RI)), information related to channel quality (Channel Quality Indicator (CQI)), information related to precoding (Precoding Matrix Indicator, (PMI)), and the like. Furthermore, the information related to SP-CSI reporting may include information related to the designation of which information is to be quantized to what bits to be transmitted. The information related to SP-CSI reporting may notify, by RRC signaling, the transmission methods in a case that multiple codewords are present, how to transmit in a case of transmitting wide band CQI and/or subband CQI, and whether to transmit the absolute value CQI information or the differential CQI information, or the like.

In the GF type 1 and the GF type 2 (SPS), the number of repetitive transmissions is configured by the RRC. The number of repetitive transmissions is always configured to be 1 in the SP-CSI reporting, and is not configurable in the RRC signaling. For example, in a case that the GF type 2 and the RRC signaling of the SP-CSI reporting are common, the CSI reporting may be performed by assuming the number of repetitions to be 1, even in a case that the number of repetitions is configured for the GF type 2, in a case that the RRC signaling is used for the SP-CSI reporting.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization signal (SS) and a Downlink Reference Signal (DL RS) are used as downlink physical signals. The downlink physical signals are not used for transmission of information output from the higher layers, but are used by the physical layer.

The synchronization signal is used for the terminal apparatus to take synchronization in the frequency domain and the time domain in the downlink. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used for the terminal apparatus to measure the downlink channel state (CSI measurement).

The downlink physical channel and the downlink physical signal are also collectively referred to as a downlink signal. The uplink physical channel and the uplink physical signal are also collectively referred to as an uplink signal. The downlink physical channel and the uplink physical channel are also collectively referred to as a physical channel. The downlink physical signal and the uplink physical signal are also collectively referred to as a physical signal.

The BCH, the UL-SCH, and the DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

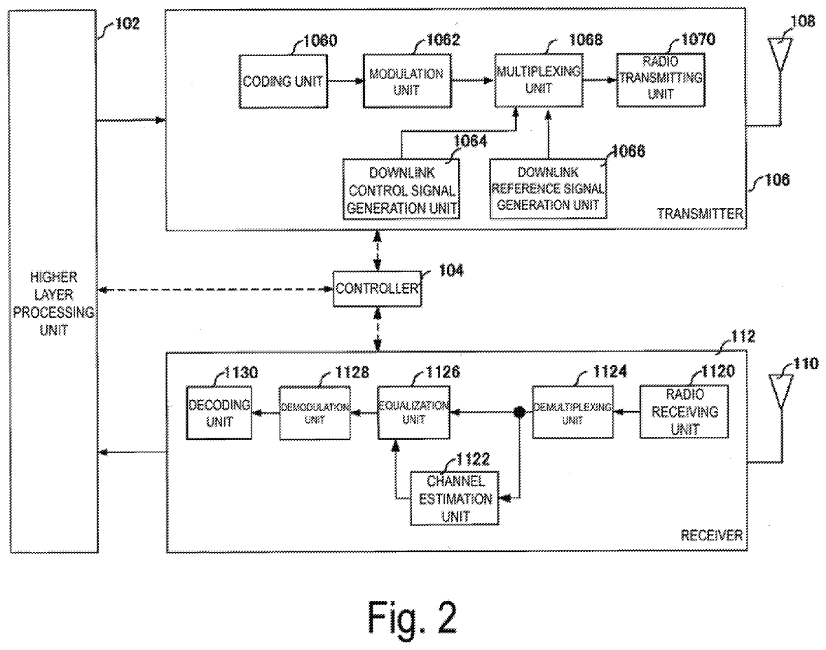

FIG. 2 is a schematic block diagram of a configuration of the base station apparatus 10 according to the present embodiment. The base station apparatus 10 includes a higher layer processing unit (higher layer processing step) 102, a controller (control step) 104, a transmitter (transmitting step) 106, a transmit antenna 108, a receive antenna 110, and a receiver (receiving step) 112. The transmitter 106 generates the physical downlink channel in accordance with a logical channel input from the higher layer processing unit 102. The transmitter 106 includes a coding unit (coding step) 1060, a modulation unit (modulating step) 1062, a downlink control signal generation unit (downlink control signal generating step) 1064, a downlink reference signal generation unit (downlink reference signal generating step) 1066, a multiplexing unit (multiplexing step) 1068, and a radio transmitting unit (radio transmitting step) 1070. The receiver 112 detects (demodulates, decodes, or the like) the physical uplink channel and inputs the content to the higher layer processing unit 102. The receiver 112 includes a radio receiving unit (radio receiving step) 1120, a channel estimation unit (channel estimating step) 1122, a demultiplexing unit (demultiplexing step) 1124, an equalization unit (equalizing step) 1126, a demodulation unit (demodulating step) 1128, and a decoding unit (decoding step) 1130.

The higher layer processing unit 102 performs processing on a higher layer than the physical layer, such as a Medium Access Control (MAC) layer, a Packet Data Convergence Protocol (PDCP) layer, a Radio Link Control (RLC) layer, and a Radio Resource Control (RRC) layer. The higher layer processing unit 102 generates information required to control the transmitter 106 and the receiver 112, and outputs the resultant information to the controller 104. The higher layer processing unit 102 outputs the downlink data (such as DL-SCH), the system information (MIB, SIB), and the like to the transmitter 106. Note that the DMRS configuration information may be notified to the terminal apparatus by using the system information (MIB or SIB), instead of the notification by using the higher layer such as RRC.

The higher layer processing unit 102 generates, or acquires from a higher node, the system information (a part of the MIB or the SIB) to be broadcasted. The higher layer processing unit 102 outputs the system information to be broadcasted to the transmitter 106 as BCH/DL-SCH. The MIB is allocated to the PBCH in the transmitter 106. The SIB is allocated to the PDSCH in the transmitter 106. The higher layer processing unit 102 generates, or acquires from a higher node, the system information (SIB) specific to the terminal apparatus. The SIB is allocated to the PDSCH in the transmitter 106.

The higher layer processing unit 102 configures various RNTIs for each terminal apparatus. The RNTI is used for encryption (scrambling) of the PDCCH, the PDSCH, and the like. The higher layer processing unit 102 outputs the RNTI to the controller 104/the transmitter 106/the receiver 112.

In a case that the downlink data (transport block, DL-SCH) allocated to the PDSCH, the system information specific to the terminal apparatus (System Information Block: SIB), the RRC message, the MAC CE, and the DMRS configuration information are not notified by using the system information, such as the SIB and the MIB, and the DCI, the higher layer processing unit 102 generates, or acquires from a higher node, the DMRS configuration information or the like and outputs the information generated or acquired to the transmitter 106. The DMRS configuration information may be configured separately for each of the uplink and the downlink, or may be inclusively configured. The higher layer processing unit 102 manages various kinds of configuration information of the terminal apparatus 20. Note that a part of the function of the radio resource control may be performed in the MAC layer or the physical layer.

The higher layer processing unit 102 receives information on the terminal apparatus, such as the function supported by the terminal apparatus (UE capability), from the terminal apparatus 20 (via the receiver 112). The terminal apparatus 20 transmits its own function to the base station apparatus 10 by a higher layer signal (RRC signaling). The information on the terminal apparatus includes information for indicating whether the terminal apparatus supports a prescribed function or information for indicating that the terminal apparatus has completed introduction and testing of the prescribed function. The information for indicating whether the prescribed function is supported includes information for indicating whether the introduction and testing of the prescribed function have been completed.

In a case that the terminal apparatus supports the prescribed function, the terminal apparatus transmits information (parameters) for indicating whether the prescribed function is supported. In a case that the terminal apparatus does not support the prescribed function, the terminal apparatus may be configured not to transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

The higher layer processing unit 102 acquires the DL-SCH from the decoded uplink data (including the CRC) from the receiver 112. The higher layer processing unit 102 performs error detection on the uplink data transmitted by the terminal apparatus. For example, the error detection is performed in the MAC layer.

The controller 104 controls the transmitter 106 and the receiver 112 based on the various kinds of configuration information input from the higher layer processing unit 102/receiver 112. The controller 104 generates the downlink control information (DCI) based on the configuration information input from the higher layer processing unit 102/receiver 112, and outputs the generated downlink control information to the transmitter 106. For example, the controller 104 configures, based on the configuration information on the DMRS input from the higher layer processing unit 102/receiver 112 (whether the configuration is the DMRS configuration 1 or the DMRS configuration 2), the frequency allocation of the DMRS (an even subcarrier or an odd subcarrier in the case of DMRS configuration 1, and any of the zeroth to the second sets in the case of the DMRS configuration 2), and generates the DCI. With the DCI, in addition to the frequency allocation of the DMRS, information on the cyclic shift of the DMRS, a coding pattern of an Orthogonal Cover Code (OCC) in the frequency domain, a coding pattern of the OCC in the time domain in a case that DMRS symbols are configured across multiple OFDM symbols, and the like may be notified. In addition to the information on the DMRS, the DCI includes various kinds of information, such as information on the MCS and the frequency allocation.

The controller 104 determines the MCS of the PUSCH in consideration of channel quality information (CSI Measurement result) measured by the channel estimation unit 1122. The controller 104 determines an MCS index corresponding to the MCS of the PUSCH. The controller 104 includes, in the uplink grant, the MCS index determined.

The transmitter 106 generates the PBCH, the PDCCH, the PDSCH, the downlink reference signal, and the like in accordance with the signal input from the higher layer processing unit 102/controller 104. The coding unit 1060 performs encoding (including repetition) using block code, convolutional code, turbo code, polar coding, LDPC code, or the like on the BCH, the DL-SCH, and the like input from the higher layer processing unit 102 by using a predetermined coding scheme/a coding scheme determined by the higher layer processing unit 102. The coding unit 1060 performs puncturing on the coded bits based on the coding rate input from the controller 104. The modulation unit 1062 performs data modulation on the coded bits input from the coding unit 1060 by using a predetermined modulation scheme (modulation order)/a modulation scheme (modulation order) input from the controller 104, such as the BPSK, QPSK, 16QAM, 64QAM, or 256QAM. The modulation order is based on the MCS index selected by the controller 104.

The downlink control signal generation unit 1064 adds the CRC to the DCI input from the controller 104. The downlink control signal generation unit 1064 encrypts (scrambles) the CRC by using the RNTI. Furthermore, the downlink control signal generation unit 1064 performs QPSK modulation on the DCI to which the CRC is added, and generates the PDCCH. The downlink reference signal generation unit 1066 generates a sequence known to the terminal apparatus as a downlink reference signal. The known sequence is determined by a predetermined rule based on a physical cell identity for identifying the base station apparatus 10 and the like.

The multiplexing unit 1068 multiplexes the PDCCHs/downlink reference signals/modulation symbols of the respective channels input from the modulation unit 1062. In other words, the multiplexing unit 1068 maps the PDCCHs/downlink reference signals/modulation symbols of the respective channels to the resource elements. The resource elements to which the mapping is performed are controlled by downlink scheduling input from the controller 104. The resource element is the minimum unit of a physical resource including one OFDM symbol and one subcarrier. Note that, in a case of performing MIMO transmission, the transmitter 106 includes the coding units 1060 and the modulation units 1062. Each of the number of the coding units 1060 and the number of the modulation units 1062 is equal to the number of layers. In this case, the higher layer processing unit 102 configures the MCS for each transport block in each layer.

The radio transmitting unit 1070 performs Inverse Fast Fourier Transform (IFFT) on the multiplexed modulation symbols and the like to generate OFDM symbols. The radio transmitting unit 1070 adds cyclic prefixes (CPs) to the OFDM symbols to generate a baseband digital signal. Furthermore, the radio transmitting unit 1070 converts the digital signal into an analog signal, removes unnecessary frequency components from the analog signal by filtering, performs up-conversion to a signal of a carrier frequency, performs power amplification, and outputs the resultant signal to the transmit antenna 108 for transmission.

In accordance with an indication from the controller 104, the receiver 112 detects (separates, demodulates, and decodes) the reception signal received from the terminal apparatus 20 through the receive antenna 110, and inputs the decoded data to the higher layer processing unit 102/controller 104. The radio receiving unit 1120 converts the uplink signal received through the receive antenna 110 into a baseband signal by down-conversion, removes unnecessary frequency components from the baseband signal, controls an amplification level such that a signal level is suitably maintained, performs orthogonal demodulation based on an in-phase component and an orthogonal component of the received signal, and converts the resulting orthogonally-demodulated analog signal into a digital signal. The radio receiving unit 1120 removes a part corresponding to the CP from the converted digital signal. The radio receiving unit 1120 performs Fast Fourier Transform (FFT) on the signal from which the CPs have been removed, and extracts a signal in the frequency domain. The signal in the frequency domain is output to the demultiplexing unit 1124.

The demultiplexing unit 1124 demultiplexes the signals input from the radio receiving unit 1120 into signals, such as the PUSCH, the PUCCH, and the uplink reference signal, based on uplink scheduling information (such as uplink data channel allocation information) input from the controller 104. The uplink reference signal resulting from the demultiplexing is input to the channel estimation unit 1122. The PUSCH and PUCCH resulting from the demultiplexing are output to the equalization unit 1126.

The channel estimation unit 1122 uses the uplink reference signal to estimate a frequency response (or a delay profile). The result of frequency response in the channel estimation for demodulation is input to the equalization unit 1126. The channel estimation unit 1122 measures the uplink channel condition (measures a Reference Signal Received Power (RSRP), a Reference Signal Received Quality (RSRQ), and a Received Signal Strength Indicator (RSSI)) by using the uplink reference signal. The measurement of the uplink channel state is used to determine the MCS for the PUSCH and the like.

The equalization unit 1126 performs processing to compensate for an influence in a channel based on the frequency response input from the channel estimation unit 1122. As a method for the compensation, any existing channel compensation, such as a method of multiplying an MMSE weight or an MRC weight and a method of applying an MLD, is applicable. The demodulation unit 1128 performs demodulation processing based on the information on a predetermined modulation scheme/modulation scheme indicated by the controller 104.

The decoding unit 1130 performs decoding processing on the output signal from the demodulation unit based on the information on a predetermined coding rate/coding rate indicated by the controller 104. The decoding unit 1130 inputs the decoded data (such as the UL-SCH) to the higher layer processing unit 102.

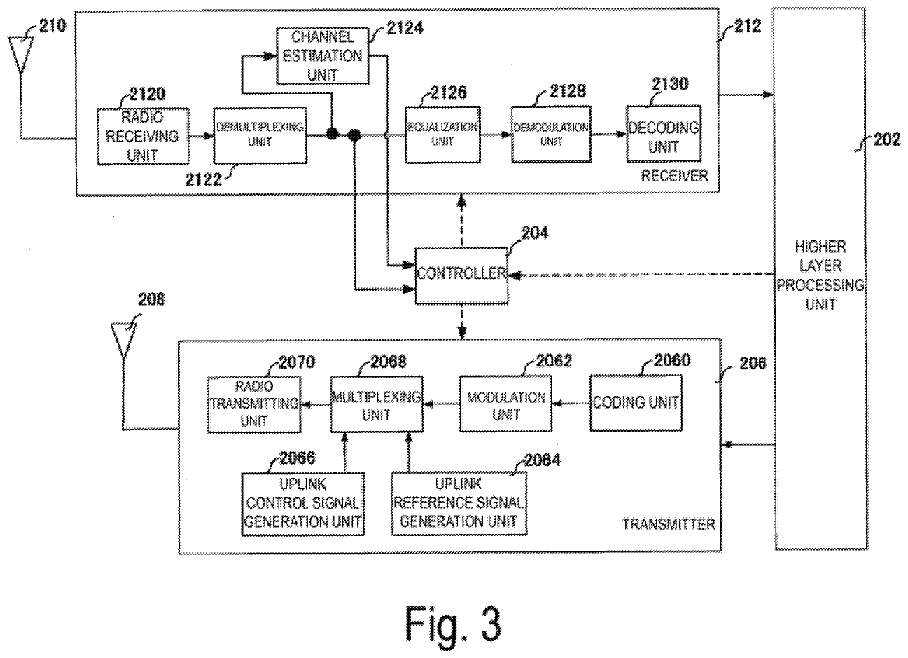

FIG. 3 is a schematic block diagram illustrating a configuration of the terminal apparatus 20 according to the present embodiment. The terminal apparatus 20 includes a higher layer processing unit (higher layer processing step) 202, a controller (control step) 204, a transmitter (transmitting step) 206, a transmit antenna 208, a receive antenna 210, and a receiver (receiving step) 212.

The higher layer processing unit 202 performs processing of the medium access control (MAC) layer, the packet data convergence protocol (PDCP) layer, the radio link control (RLC) layer, and the radio resource control (RRC) layer. The higher layer processing unit 202 manages various kinds of configuration information of the terminal apparatus itself. The higher layer processing unit 202 notifies the base station apparatus 10 of information for indicating terminal apparatus functions supported by the terminal apparatus itself (UE Capability) via the transmitter 206. The higher layer processing unit 202 notifies the UE Capability by RRC signaling.

The higher layer processing unit 202 acquires the decoded data, such as the DL-SCH and the BCH, from the receiver 212. The higher layer processing unit 202 generates the HARQ-ACK from a result of the error detection of the DL-SCH. The higher layer processing unit 202 generates the SR. The higher layer processing unit 202 generates the UCI including the HARQ-ACK/SR/CSI (including the CQI report). In a case that the DMRS configuration information is notified by the higher layer, the higher layer processing unit 202 inputs the information on the DMRS configuration to the controller 204. The higher layer processing unit 202 inputs the UCI and the UL-SCH to the transmitter 206. Note that some functions of the higher layer processing unit 202 may be included in the controller 204.

The controller 204 interprets the downlink control information (DCI) received via the receiver 212. The controller 204 controls the transmitter 206 in accordance with PUSCH scheduling/MCS index/Transmission Power Control (TPC), and the like acquired from the DCI for uplink transmission. The controller 204 controls the receiver 212 in accordance with the PDSCH scheduling/the MCS index and the like acquired from the DCI for downlink transmission. Furthermore, the controller 204 identifies the frequency allocation of the DMRS according to the information on the frequency allocation of the DMRS included in the DCI for downlink transmission and the DMRS configuration information input from the higher layer processing unit 202.

The transmitter 206 includes a coding unit (coding step) 2060, a modulation unit (modulating step) 2062, an uplink reference signal generation unit (uplink reference signal generating step) 2064, an uplink control signal generation unit (uplink control signal generating step) 2066, a multiplexing unit (multiplexing step) 2068, and a radio transmitting unit (radio transmitting step) 2070.

In accordance with the control by the controller 204 (in accordance with the coding rate calculated based on the MCS index), the coding unit 2060 codes the uplink data (UL-SCH) input from the higher layer processing unit 202 by convolutional coding, block coding, turbo coding, or the like.

The modulation unit 2062 modulates the coded bits input from the coding unit 2060 (generates modulation symbols for the PUSCH) by a modulation scheme indicated from the controller 204/modulation scheme predetermined for each channel, such as BPSK, QPSK, 16QAM, 64QAM, and 256QAM.

The uplink reference signal generation unit 2064 generates a sequence determined from a predetermined rule (formula), based on a physical cell identity (PCI), which is also referred to as a Cell ID, or the like, for identifying the base station apparatus 10, a bandwidth in which the uplink reference signals are mapped, a cyclic shift, parameter values to generate the DMRS sequence, further the frequency allocation, and the like, in accordance with an indication by the controller 204.

In accordance with the indication from the controller 204, the uplink control signal generation unit 2066 encodes the UCI, performs the BPSK/QPSK modulation, and generates modulation symbols for the PUCCH.

In accordance with the uplink scheduling information from the controller 204 (transmission interval in the SPS for the uplink included in the RRC message, resource allocation included in the DCI, and the like), the multiplexing unit 2068 multiplexes the modulation symbols for the PUSCH, the modulation symbols for the PUCCH, and the uplink reference signals for each transmit antenna port (in other words, the respective signals are mapped to the resource elements).

The radio transmitting unit 2070 performs Inverse Fast Fourier Transform (IFFT) on the multiplexed signals to generate OFDM symbols. The radio transmitting unit 2070 adds CPs to the OFDM symbols to generate a baseband digital signal. Furthermore, the radio transmitting unit 2070 converts the baseband digital signal into an analog signal, removes unnecessary frequency components from the analog signal, converts the signal into a signal of a carrier frequency by up-conversion, performs power amplification, and transmits the resultant signal to the base station apparatus 10 via the transmit antenna 208.

The receiver 212 includes a radio receiving unit (radio receiving step) 2120, a demultiplexing unit (demultiplexing step) 2122, a channel estimation unit (channel estimating step) 2144, an equalization unit (equalizing step) 2126, a demodulation unit (demodulating step) 2128, and a decoding unit (decoding step) 2130.

The radio receiving unit 2120 converts the downlink signal received through the receive antenna 210 into a baseband signal by down-conversion, removes unnecessary frequency components from the baseband signal, controls an amplification level such that a signal level is suitably maintained, performs orthogonal demodulation based on an in-phase component and an orthogonal component of the received signal, and converts the resulting orthogonally-demodulated analog signal into a digital signal. The radio receiving unit 2120 removes a part corresponding to the CP from the digital signal resulting from the conversion, performs the FFT on the signal from which the CP has been removed, and extracts a signal in the frequency domain.

The demultiplexing unit 2122 separates the extracted signal in the frequency domain into the downlink reference signal, the PDCCH, the PDSCH, and the PBCH. A channel estimation unit 2124 uses the downlink reference signal (such as the DM-RS) to estimate a frequency response (or delay profile). The result of frequency response in the channel estimation for demodulation is input to the equalization unit 1126. The channel estimation unit 2124 measures the uplink channel state (measures a Reference Signal Received Power (RSRP), a Reference Signal Received Quality (RSRQ), a Received Signal Strength Indicator (RSSI), and a Signal to Interference plus Noise power Ratio (SINR)) by using the downlink reference signal (such as the CSI-RS). The measurement of the downlink channel state is used to determine the MCS for the PUSCH and the like. The measurement result of the downlink channel state is used to determine the CQI index and the like.

The equalization unit 2126 generates an equalization weight based on an MMSE criterion, from the frequency response input from the channel estimation unit 2124. The equalization unit 2126 multiplies the input signal (the PUCCH, the PDSCH, the PBCH, and the like) from the demultiplexing unit 2122 by the equalization weight. The demodulation unit 2128 performs demodulation processing based on information of the predetermined modulation order/the modulation order indicated by the controller 204.

The decoding unit 2130 performs decoding processing on the output signal from the demodulation unit 2128 based on information of the predetermined coding rate/the coding rate indicated by the controller 204. The decoding unit 2130 inputs the decoded data (such as the DL-SCH) to the higher layer processing unit 202.

A program running on an apparatus according to an aspect of the present invention may serve as a program that controls a Central Processing Unit (CPU) and the like to cause a computer to operate in such a manner as to realize the functions of the above-described embodiments according to an aspect of the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Note that the apparatuses in the above-described embodiments may be partially enabled by a computer. In that case, a program for realizing the functions of the embodiments may be recorded on a computer readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. The “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used for transmission of the program over a network such as the Internet or over a communication line such as a telephone line, and may also include a medium that retains a program for a fixed period of time, such as a volatile memory within the computer system for functioning as a server or a client in such a case. The program may be configured to realize some of the functions described above, and also may be configured to be capable of realizing the functions described above in combination with a program already recorded in the computer system.

Each functional block or various characteristics of the apparatuses used in the above-described embodiments may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. In a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of one aspect of the present invention defined by claims, and embodiments that are made by suitably combining technical means disclosed according to the different embodiments are also included in the technical scope of the present invention. A configuration in which constituent elements, described in the respective embodiments and having mutually the same effects, are substituted for one another is also included in the technical scope of the present invention.

### INDUSTRIAL APPLICABILITY

An aspect of the present invention can be preferably used in a base station apparatus, a terminal apparatus, and a communication method. An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

10 Base station apparatus
20 Terminal apparatus
10a Range within which base station apparatus 10 is connectable to terminal apparatus
102 Higher layer processing unit
104 Controller
106 Transmitter
108 Transmit antenna
110 Receive antenna
112 Receiver
1060 Coding unit
1062 Modulation unit
1064 Downlink control signal generation unit
1066 Downlink reference signal generation unit
1068 Multiplexing unit
1070 Radio transmitting unit
1120 Radio receiving unit
1122 Channel estimation unit
1124 Demultiplexing unit
1126 Equalization unit
1128 Demodulation unit
1130 Decoding unit
202 Higher layer processing unit
204 Controller
206 Transmitter
208 Transmit antenna
210 Receive antenna
212 Receiver
2060 Coding unit
2062 Modulation unit
2064 Uplink reference signal generation unit
2066 Uplink control signal generation unit
2068 Multiplexing unit
2070 Radio transmitting unit
2120 Radio receiving unit
2122 Demultiplexing unit
2124 Channel estimation unit
2126 Equalization unit
2128 Demodulation unit
2130 Decoding unit

1. A terminal apparatus for communicating with a base station apparatus, the terminal apparatus comprising:
a radio receiving unit configured to receive a CSI reference signal;
a controller configured to calculate channel state information (CSI); and
a transmitter configured to transmit the CSI, wherein
the controller calculates the CSI, based on an RRC parameter related to the number of repetitions in a case that a transport block error rate to be used in calculating the CSI is configured by a higher layer processing unit, and calculates the CSI that is not dependent on the RRC parameter related to the number of repetitions in a case that the transport block error rate to be used in calculating the CSI is not configured by the higher layer processing unit.

2. The terminal apparatus according to claim 1, wherein
the controller further calculates the CSI, based on an RRC parameter related to redundancy version for repetition, in a case that the transport block error rate is configured by the higher layer processing unit.

3. The terminal apparatus according to claim 1, wherein
the controller calculates the CSI by a different CSI process depending on the transport block error rate.

4. A base station apparatus for communicating with a terminal apparatus, the base station apparatus comprising:
a radio receiving unit configured to receive channel state information (CSI) transmitted by the terminal apparatus;
a higher layer processing unit configured to configure a transport block error rate;
a downlink control signal generation unit configured to generate a downlink control signal including a parameter of PDSCH; and
a radio transmitting unit configured to transmit the transport block error rate and the downlink control signal to the terminal apparatus, wherein
the downlink control signal generation unit generates downlink control information, based on a higher layer parameter related to the number of repetitions by the terminal apparatus, in a case that the transport block error rate is configured in the higher layer processing unit.
